(19) United States
(12) Patent Application Publication
(10) Pub. No.: US 2011/0101692 A1
(43) Pub. Date: May 5, 2011

(54) AIRBORNE WIND POWERED GENERATOR

(76) Inventor: Nykolai Bilaniuk, Ottawa (CA)

(21) Appl. No.: 12/999,638

(22) PCT Filed: Jul. 16, 2009
(86) PCT No.: PCT/CA09/00995

§ 371 Date: Dec. 17, 2010

Related U.S. Application Data
(60) Provisional application No. 61/081,050, filed on Jul. 16, 2008.

(51) Int. Cl. F03D 7/00; F03D 9/00

(52) U.S. Cl. 290/44; 290/55

(57) ABSTRACT

A wind powered generator is described that may take advantage of the strong wind present at higher altitudes above terrain than can feasibly be reached by traditional tower mounted wind generators. It makes use of a combination of lift sources. The generator comprises an envelope filled with a lifting gas that enables the system to rise in little or no wind, and wings that provide additional lift when there is wind, to thereby prevent the wind from blowing the tethered generator to the ground. The airborne wind powered generator is able to both rise aloft and land unattended. Power is extracted from the wind by means of turbine rotors that drive electric generators.

### BACKGROUND TO THE INVENTION

1. Field of the Invention

This invention relates generally to the generation of electrical power from wind energy, and more particularly to the harnessing of the greater wind energy available at higher altitudes than those in which terrestrial tower mounted systems operate.

2. Description of the Prior Art

Renewable energy resources are attracting substantial interest in recent years because other established power sources such as fossil fuels and nuclear power are considered to have serious drawbacks. For instance, the supply of fossil fuels is finite, and some fossil fuels, notably oil and natural gas, are beginning to become uneconomical to extract from the ground. One possible alternative to fossil fuels is nuclear power, but there continue to be ongoing concerns regarding the safety and cost of this technology.

As one of the more promising alternative energy technologies, wind power has been growing in popularity. Most wind turbines are installed on the ground on top of high towers. There are good motivating factors for placing wind turbines as high as possible above terrain. The main advantage of having an elevated turbine is that as elevation above terrain increases, winds become both stronger and steadier. The energy available in a wind of a given magnitude is greatly enhanced with an increase in wind speed, with gains proportional to the cube of the velocity of the airflow. Although the lower air pressures at higher altitudes do reduce the wind's energy, there is a height range, approximately extending to an altitude of 1 kilometer, where this reduction is far outstripped by the wind-speed related increase, being only directly proportional to air density.

These facts mean that there is much more energy available in the wind at higher elevations above ground level than may feasibly be reached using terrestrial towers. The cost of tower construction increases non-linearly with height, since as a tower gets taller, its structural framework must also become both stronger and heavier. Doubling the height of a given tower design may result in a quadrupling of the total cost of construction, a reality which quickly renders certain otherwise very attractive wind generation altitudes economically unreachable in the earliest planning stage.

One alternative to a fixed terrestrial tower mounting is to loft the wind generator to an altitude where the higher energy winds are available. An airborne wind turbine may be tethered to the ground at a fixed or semi-fixed surface site, with the turbine flying above. Unlike the non-linear cost effects seen when increasing the height of a tower, the cost of lengthening a flexible tether increases approximately in proportion to length.

There are other compelling advantages of airborne wind turbines over traditional, ground-based turbines. The higher elevation above the ground level means that a stronger, steadier wind will be able to act on the turbine's rotor blades. As a result, given two turbines of equal size, the turbine situated at a higher altitude will produce a greater amount of power.

At higher elevations above the ground level, a steadier wind may be found. Because of this fact, a given wind turbine can produce power closer to its nominal “nameplate” capacity a larger fraction of the time. A turbine that is located at a higher elevation is more typically able to achieve a higher proportion of its operating time delivering its maximum output. The proportion of rated energy production capacity that is achieved by a generator on average is called its capacity factor. Other consideration being equal, a wind turbine located at a higher elevation will typically exhibit a higher capacity factor than would an identical unit in service at a lower height. An airborne wind turbine has the potential to capitalize on the height-related increase in capacity factor to quite an extreme degree.

By using airborne turbines that have a tether cost that increases generally linearly with length or achieved height, as opposed to a tower that has a cost that increases approximately with the square of the height, the cost of achieving higher elevations scales more economically with airborne, tethered turbines than with terrestrial turbines.

Airborne wind turbines may also suffer fewer constraints as to where they may be economically located. Because of their distance from other installations on the ground, it may in some cases be possible to place airborne turbines closer to their market. This is an important consideration in electrical generation, since there is a real price to be paid in transmission losses and delivery infrastructure when powering electrical loads over long distances. Even if transmission system could be established and maintained at zero cost, all losses occurring during transmission are reflected in a corresponding increase in the cost of the product at delivery.

In some areas, traditional wind generation may not be topologically feasible. Mountainous terrain may present an obstacle to prevailing wind flow, leaving otherwise suitable tower sites in a leeward wind shadow. Terrain effects may be mitigated partially or even completely if the generator is flying above problematic surface features, and an elevated wind turbine is able to access the more regular wind found in higher altitudes.

In view of the foregoing advantages, it is not surprising that the airborne tethered wind turbine has attracted some interest. Tethered wind turbines must be taken aloft in order to function optimally. This can be done by any variation on one of two principal lift mechanisms: lift obtained from the wind itself by means of wings or kites, or buoyancy from an inflatable body filled with a lifting gas.

The use of wind as the source of lift for an airborne wind turbine is evident in multiple prior art documents. Heavier-than-air lifting devices typically depend mostly on Bernoulli's Principle for lift, occasionally relying also on contributions from the Magnus Effect or other effects.

There are further subclassifications for airborne wind turbines, as they may be further sorted according to what role the lifting device plays in extracting power from the wind: none, passive, or active.

One example where the lifting devices, in this case a set of kites on a string, play no appreciable role in extracting power from the wind is the kite ladder design described in U.S. Pat. No. 7,317,261 by Rolt.

There are likewise examples where the lifting device plays a passive role, typically by shaping the airflow to improve power extraction.

In the kite-supported paddlewheel rotor of U.S. Pat. No. 4,659,940 by Sheperd, the kite is so close to the paddlewheel that it may affect airflow around the paddlewheel.

Knott describes another design wherein the lifting device plays a passive role in U.S. Pat. No. 7,210,896. Knott envisions a kite with an airfoil profile that places an array of small propeller turbines in such a way as to take advantage of the increased airspeed at certain locations around the airfoil.

There are two designs that use heavier-than-air lifting devices in an active mode for power generation, and both place the generating apparatus on the ground.

U.S. Pat. No. 6,616,402 by Selsam envisions a string of multiple kites that are supported by the wind but are tethered together on one tether and rotate together like rotors, the torsion in the tether turning a ground-based generator.

Olson's U.S. Pat. No. 7,188,808 describes a cluster of kites, each of which has a separate tether to the ground, but which work together with a ground-based apparatus to harness the rotary motion of the tethers. Olson's FIG. 26 is particularly interesting. It shows a kite shaped approximately like an airplane, while the present invention involves an airship shaped approximately like an airplane.

All of the above designs are heavier-than-air and are dependent on Bernoulli's Principle for lift. This also means they share a common defect, in that they cannot easily operate when there is little or no wind. Most specifically, it can be difficult to launch the above designs in such a way that they can operate continuously and autonomously. Given that wind speed is by nature variable, it is inevitable that sometimes the wind will be inadequately strong for a system to operate, and at other times the system must be brought to the ground because the wind is too strong. In some cases, such as the Selsam design, it is doubtful the system can operate stably even in the face of moderate winds. In addition, none of these devices can lift off from the ground unattended. Maintaining a ground crew on hand to service them adds to their cost of operation.

The use of a lighter-than-air, or aerostatic lifting approach is more promising in some very important ways than one based on heavier-than-air, or aerodynamic techniques. Buoyant lifting bodies are evident in several existing patents. These designs may be further distinguished according to the role the lifting body plays in extracting power from the wind: none, passive, or active.

The first type, a lifting body strictly for lift, is shown by Macedo in U.S. Pat. No. 7,129,596, in a system whereby a lifting body pulls a paddlewheel rotor frame aloft at one end while the other end of the frame is anchored by a tether to the ground.

U.S. Pat. No. 4,166,596 to Mouton, and U.S. Pat. No. 4,350,899 to Benoit demonstrate lifting bodies which are not themselves part of the rotor, but which passively duct the air with the intention of accelerating it to obtain an increased wind interception area and thus greater power output. Mouton describes a lighter-than-air turbine using a hollow cylindrical airship with counter-rotating propellers. Alternatively, Benoit U.S. Pat. No. 4,350,899 describes a lighter than air wind turbine using internal folded ducts to guide the flow of air. One active variation on the idea of using the lifting body for something other than just lift can be seen in U.S. Pat. No. 4,207,026, to Kushto. This design teaches a tethered lighter-than-air wind turbine in which the lifting body is also the rotor, and which rotates about its axis and in which one end is attached to the tether. Another U.S. Pat. No. 4,450,364 to Benoit, describes a lighter than air wind turbine in which the lifting body rotates, but is tethered at both ends.

Airborne tethered wind turbines that rely solely on a lighter-than-air buoyant lifting body for their lift do not require that strong wind be constantly present in order to stay airborne. However, as the wind gets stronger, they get blown downwind which, by nature of the fact that they are tethered to a tether point, pushes them closer to the ground. How much closer depends on the ratio of the net buoyant force to the drag force. In these designs, there is risk of damage as the rotating structure strikes the ground. Once again, the availability of a ground crew is essential. Thus, in the case of heavier-than-air tethered wind turbines, ground support is needed to help the system take off successfully, while in the case of buoyant lifting body tethered wind turbines, ground support is needed to help the system land safely.

There are some devices that claim to use more than one lifting mechanism simultaneously. U.S. Pat. No. 7,335,000 to Ferguson, describes a device similar to Benoit's U.S. Pat. No. 4,450,364 patent, utilizing a tethered lighter-than-air wind turbine rotating about its axis and in which both ends are attached to the tether, but in this case it is claimed that the wind contributes to the lift via the Magnus effect. A more complex system is offered by Pugh in U.S. Pat. No. 4,486,669. Here a natural gas powered hot air balloon in combination with a helicopter type rotor lifts a kite containing multiple propellers that each drive a generator.

Although using two sources of lift, the Ferguson and Pugh systems do not make it possible to conduct unattended takeoffs and landing. In the case of Ferguson, the Magnus effect contribution to the lift is at best only a modest portion of the total lift, so that this system behaves in essential respects like a buoyant lifting body with a tethered wind turbine.

The present invention uses both sources of lift in a novel way to obtain a level of stability, performance, and economy not possible with either source of lift alone. Its main advantages are the ability to take off and land unattended, to do so without a winch, all while using less lifting gas than other buoyant lifting body tethered wind turbines.

The present invention makes better use of the available wind resources to generate electrical power more efficiently than conventional terrestrial wind turbines. In some situations is able to do so with a lower overall costs and fewer risks than competing airborne systems.

Two of the underlying principles behind the system of the current invention are the use of aerostatic lift generated from at least one envelope filled with a lighter-than-air gas in conjunction with aerodynamic lift generated by the differential pressures arising from the motion of the airflow across the surfaces of an airfoil. The latter aerodynamic lift is often explained by the application of Bernoulli's Principle. It should be noted in this regard that since the relevant Bernoulli equation is itself based on Newton's laws of motion, the lifting force generated due to the motion of air may also be predicted from Newton directly. Regardless of the explanatory approach, this specification will refer to the lifting force generated across an airfoil as aerodynamic lifting force, or simply aerodynamic lift.

The two phenomena of aerostatic and aerodynamic lift have individually been used in many prior art airship systems. The current invention utilizes both types of lift in a hybrid approach, a combination of an airship lofted by a lighter-than-air gas providing buoyancy irrespective of air motion, and airplane-like wings that provide a lift dependent on the wind speed.

When a lighter-than-air airship is exposed to a strong wind with a significant horizontal component, it is blown downwind by virtue of its having a large surface area on which the wind can act. If this same airship is tethered and then exposed to the same strong wind, it will move in a curved manner. More specifically, the airship will begin to trace an arc that will cause it to move downwardly until the horizontal force being applied by the wind on the airship reaches an equilibrium with the horizontal component of the tether's resisting force, and the vertical lift force that is being applied by the lighter-than-air gas and the wind moving over the wings are in equilibrium with the force of gravity and the vertical component of the tether force. It would be desirable to provide an airship with means for compensating for the wind such that its response to the wind is broadly predictable and controllable, in order to reduce the risk of damage that might occur from striking the ground and to ensure that the airship may be kept at the desired altitude.

The invention in its general form will first be described, and then its implementation in terms of specific embodiments will be detailed with reference to the drawings following hereafter. These embodiments are intended to demonstrate the principle of the invention, and the manner of its implementation. The invention in its broadest and more specific forms will then be further described, and defined, in each of the individual claims which conclude this Specification.

### SUMMARY OF THE INVENTION

According to one aspect of the invention, an airborne wind power generator is provided with an airship fuselage containing an internal gas envelope, which may be filled with a lighter-than-air gas such as helium or hydrogen to create an upwardly directed aerostatic lifting force due to the relative buoyancy of the contained gas with respect to the air in the surrounding atmosphere. This aerostatic lift remains relatively constant for a given ambient air pressure, regardless of the horizontal relative speed of the air surrounding the airship.

In a second aspect of the invention, at least one main airfoil is provided which creates an additional upwardly directed aerodynamic lifting force due to the differential pressures arising from the motion of the airflow across its upper and lower surfaces. The aerodynamic lift may vary in direct proportion to the horizontal relative speed of the air surrounding the airship. This characteristic causes the system to naturally “hunt” toward a stable wind speed, even absent active control systems to achieve that objective, stabilizing at a higher altitude than would occur in the absence of the airfoil.

In a third aspect of the invention, a tethering system is provided to attach the airship to a relatively fixed anchor point on the Earth's surface. This tethering system may consist of a single tether point that is located on the underside of the airship, which may connect the airship via a load-bearing tether such as a line or cable to a remote tether point mounted on a building, vehicle, or on the ground.

According to another aspect of the invention, a wind generator system is attached to the airship in such a fashion as to capture kinetic energy from the motion of the air mass against the generator and convert the captured energy to electrical power. The wind generator system may consist of one or more wind turbines fitted with an array of rotor blades arranged radially about an axis of rotation, such that the action of the wind against the rotor causes the blades to turn and drive one or more electrical generators or alternators. Such generators or alternators, collectively hereafter referred to as “generators”, may be either connected to the rotor directly or via an intervening mechanical transmission system.

In an optional variant of the invention, the rotary electrical generators may drive onboard air compressors which capture ambient air from about the airship and compress it. According to this variant, the compressed air may be delivered to the surface via a pneumatic transmission line, such as a flexible high-pressure hose. In another variant the onboard air compressors may be mechanically coupled directly to output of rotors by a suitable mechanical transmission. In the pneumatic variants, the pressurized air may be stored for later use in a pressure storage vessel, or may directly drive a ground-based pneumatically driven device, for example an electrical generator.

In an optional aspect of the invention, the wind generator rotor blades may be provided with blade pitch controls allowing the dynamic adjustment of rotor rate of rotation and energy capture characteristics.

In yet another aspect of the invention, an electrical energy transmission medium is provided which can convey electrical power from the wind generator to an electrical load connection which may be situated either on the airship itself or at some point remote to it. The load connection may feed into any sink of the electrical power, such as a specific electrically powered device, a charging system for a storage battery or the like, or with appropriate power conditioning, the general electrical distribution grid.

The electrical power transmission medium may comprise a power transmission cable or cables to conduct the generated electrical power to a ground-based electrical load. In such the power transmission cable or cables may be integrated with the tethering system in the form of a single sheathed member that comprises both the load-bearing tether and the power transmission cabling.

In another variant of the invention, the integrated load-bearing and power transmission tether may further incorporate signal-transmission circuits for electronically directing the flight controls or other onboard devices, or to receive information from sensors mounted on the airship. In an alternate embodiment, the signal-transmission facility may be provided by wireless communication to and from the airship. Airship sensors, controls, and other onboard devices may be powered locally aboard the craft via a power tap on the output connections of the wind generator system or may be provided with power from the ground through reverse use of the power transmission cables or by secondary power delivery lines connected thereto. Provision may be made in for form of an auxiliary battery backup power supply to allow onboard devices to continue to operate in a zero wind condition.

In an optional but preferred aspect of the invention, flight stabilizers may be mounted on the airship to bias the craft's flight attitude with respect to pitch, yaw and roll, and to ensure that the power generating wind turbines are aimed at the optimal angle to generate power from the movement of the wind. Such stabilizers may act independently of, or in conjunction with, the presence of dihedra in the airship's airfoils. Such stabilizers may take the form of vertical tailfin(s) or horizontal tailplane(s) when preferably mounted towards the aft end of the fuselage, or alternatively may be fitted forward in a canard configuration. Another alternative stabilizing arrangement may consist of a pair of fins mounted at angles between the horizontal and vertical planes, as for example a “V” tail.

According to another preferred feature of the invention, the flight stabilizers may be provided with positionable active control surfaces to allow for dynamic adjustment of the attitude of the airship during flight. Such active controls if present may be actuated by an automatic control system provided with input from sensors respecting the orientation of the airship in space.

In another optional aspect of the invention, one or more ballast gas envelopes or ballonets may be mounted within the airship envelope. If used, these ballonet are designed to be inflated or deflated in order to regulate the overall buoyancy of the airship to compensate for changes in ambient air pressure and other atmospheric conditions, and/or to purposely raise or lower the airship. In one preferred embodiment, the deflation of the ballonet is all that is required to cause the airship to take off, and conversely inflation of the ballonet to cause a landing. This feature may allow the airship to conduct an unassisted take-off or landing, for example to avoid extreme and potentially damaging weather conditions.

In another variant of the invention, the main airfoils are preferably provided with a large lift-to-drag ratio at typical wind speeds to assist in maintaining the altitude of the airborne wind-powered generator as the wind speed changes. Additionally, in most embodiments the main airfoils have active control surfaces arranged laterally on the left and right sides of the airship, which can be independently manipulated to adjust the lift and roll of the airship.

In another optional aspect of the invention, an undercarriage or landing gear may be attached to the underside of the main airfoil, consisting of posts with or without horizontal rails or skids for ground engagement. The undercarriage may be sized to ensure that the rotor blades of the wind generator turbine will not contact the ground as the airship lands. If used, the undercarriage may also preferably have shock absorbing devices fitted to absorb and dissipate sudden forces during terminal ground approach.

According to another optional aspect of the invention, either the main airfoil along with the mounted turbine nacelles or the main airfoil-mounted turbine nacelles may be rotated to a position that will ensure that the turbine rotors are less likely to strike the ground and to reduce the undercarriage height requirements for rotor ground clearance. The orientation of the turbine blades may also be adjusted to dynamically vary the turbine's lift to drag ratio, since as a trailing rotor is rotated upward towards a horizontal plane, the overall drag force is lessened due to the reduced area of wind intercept. While in the rotated attitude the horizontal component of the turbine's drag force is reduced, and the vertical component provides an additional source of lift.

In yet another optional aspect of the invention, the airship may be equipped with a lightning arrestor and associated grounding cables. These grounding cables may hang free below the craft, such that they will contact the earth when the craft is not in flight, thereby shunting damaging environmental electrical discharges away from the craft while it is parked on the earth in the event of an electrical storm.

In another optional aspect of the invention, embodiments of the airborne wind powered generator may include either automatic or manual flight controls, or any combination of both in order to control the flight of the airship. Automated flight control systems may derive input data from one or more types of sensors such as anemometers or other wind speed indicators, gyroscopes, and ground based sensors via telemetry, and may compute control signals or sequences to be delivered to the available flight dynamics controls in order to effect unattended or semi-automated operation.

The foregoing summarizes the principal features of the invention and some of its optional aspects. The invention may be further understood by the description of the preferred embodiments which now follow.

### BRIEF DESCRIPTION OF THE DRAWINGS

FIG. 1 is a perspective diagram of a preferred embodiment of the invention.

FIG. 2 shows the operation of the ballonet ballasting system.

FIG. 3 shows the rotation of the nacelles, used in some embodiments

FIG. 4 shows a method for mounting the wing surface to a soft-skinned variant of the invention.

FIG. 5 is a front view of a descending keel-type tether according to a variant of the invention.

FIG. 5a is a perspective view of a descending keel-type tether according to a variant of the invention.

FIG. 6 is a perspective view of a multi-conductor high tension unified tether according to a variant of the invention.

FIG. 7 is a perspective diagram of the tether point on the ground.

FIG. 8 is a block diagram of an automated flight control system used in one embodiment of the invention.

FIG. 9 is a top view of the preferred embodiment of the invention in flight, showing the directions of the various forces acting on it.

FIG. 10 is a side view of the preferred embodiment of the invention in flight, showing the directions of the various forces acting on it.

FIG. 11 is a side view of the forces arising according to some embodiments during flight as a result of the rotation of the nacelles.

FIG. 12 is a side view of an additional force arising according to some embodiments during flight as a result of the operation of certain control surfaces on the main wing and tailplane.

### DETAILED DESCRIPTION OF THE PREFERRED EMBODIMENTS

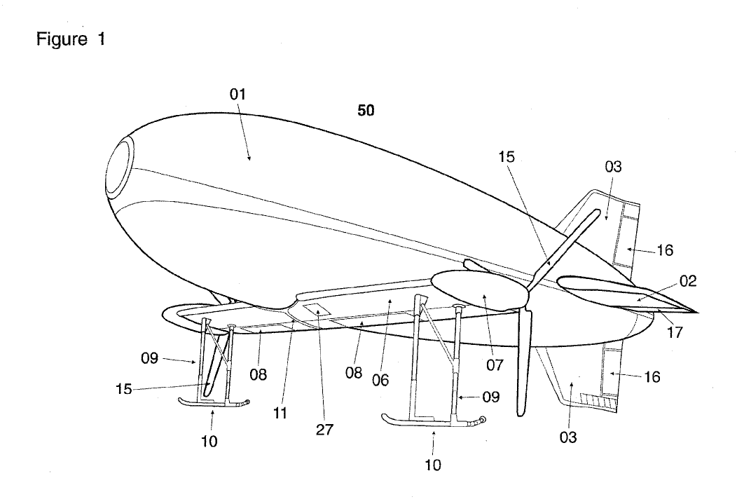

FIG. 1 depicts the airship-wind turbine combination 50 of the present invention. In the preferred embodiment, the nonrigid dirigible-like airship fuselage 20 contains an aerostatic gas envelope 1, which is filled with a lighter-than-air lifting gas such a helium or hydrogen, to provide a net buoyant force on the flight platform. Helium is usually preferable due to safety and handling factors, because it is non-flammable. Helium does however have some disadvantages with respect to cost, availability, and physical characteristics which may weigh in favor of hydrogen lift in certain circumstances.

A fixed airfoil member is provided in the form of main wings 6 to impart to the airship a second lifting force component due to aerodynamic effects in response to airflow across the surfaces of the wing, and have a cross section that is shaped to provide an upwardly directed lifting force related to the relative airspeed when exposed to the wind. Wing dimensions, mass, and lift characteristics preferably reflect a large lift-to-drag ratio at typical wind speeds, in order to contribute to the self regulation of the position of the airship 50 as the wind speed changes. Main wing 6 may also be shaped or mounted such that the left and right hand sides project their ends upwards, in order to create a dihedral effect and stabilize airship 50 with respect to roll during flight.

Also depicted in FIG. 1, main wing 6 is provided with a centrally mounted tether point 11 for harnessing airship 50 to the earth's surface via a flexible load-bearing tether. Optionally, a swivel joint may be used to couple the tether to airship 50, allowing pivoting and avoiding cable twist.

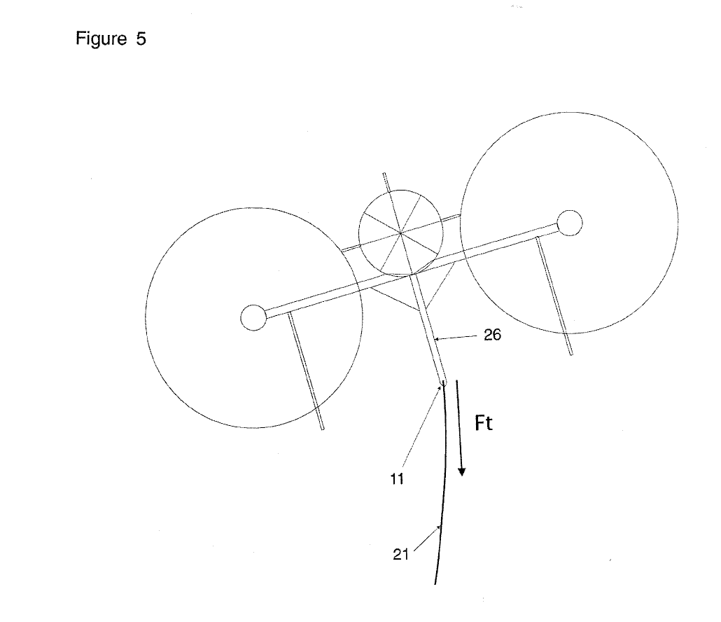

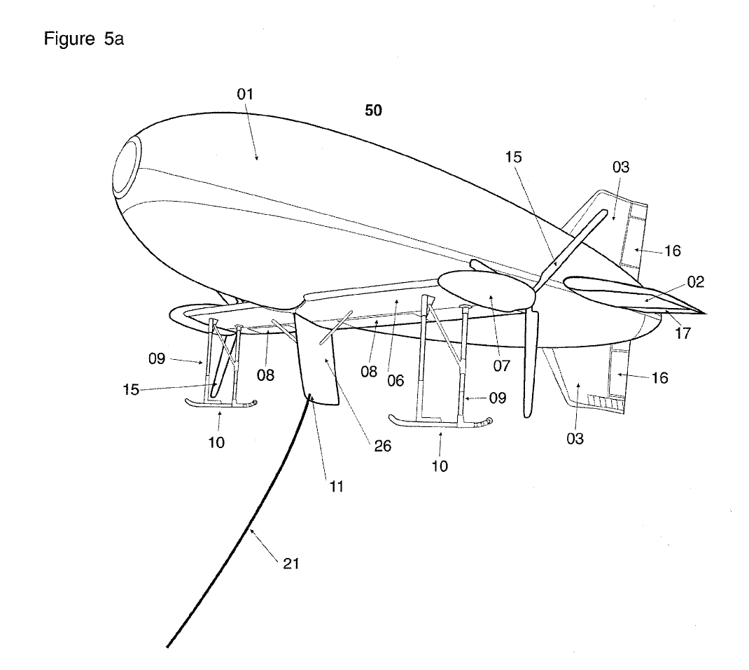

FIGS. 5 and 5a shows, in perspective and front view respectively, an alternate arrangement for attaching the tether to airship 50, which has the advantage of deriving a roll-correcting force from the tether tension force, labeled as in FIG. 5a as Ft. A vertical keel-type member 26 is attached to the underside of main wing 6 along the nose/tail centerline of nonrigid fuselage 20. A pair of bilaterally symmetrical struts may be provided to maintain tether keel 26 in a perpendicular orientation with respect to the extension of wing 6. According to this variant, the tether attachment point 11 for load-bearing tether 21 is provided near the base of keel 26. During flight, keel 26 acts in the manner of a lever, and will tend to orient itself vertically due to the vertical component of tether tension Ft and the force of gravity, providing a restorative torque and causing airship 50 to exhibit a tendency toward a horizontally level flight attitude.

As keel 26 is not required to be rigid in the vertical direction, another variation, not shown in the Figures, has a segmented keel member which is extensible using a hinge or slide. In this case one section collapses over or into another one or more additional sections in the style of a sailboat centerboard during landing.

Load-bearing tether 21 can be either a integrated type that has both the electrical conductors and the mechanical tensile strength members in one sheath. Alternatively, tether 21 may have a separate mechanical member, such as relatively inexpensive steel towing cable, with separate electrical wires supported from it periodically along its length.

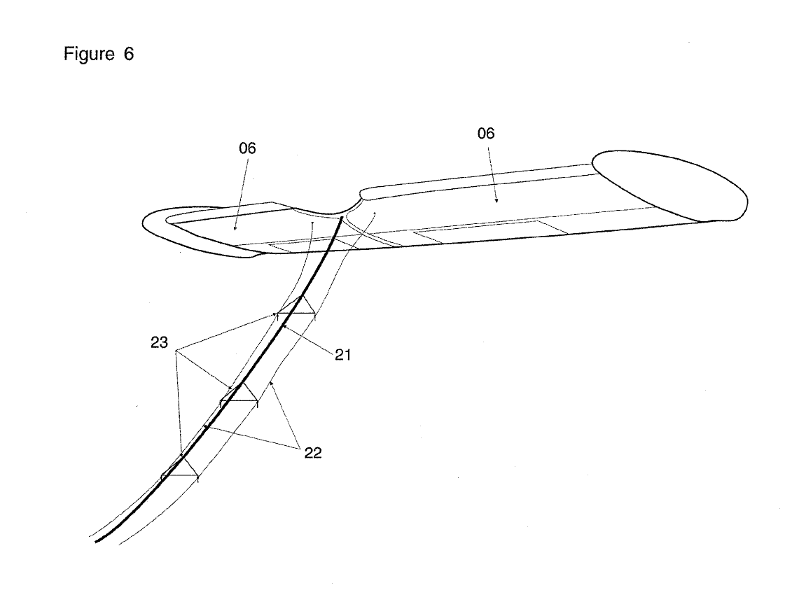

FIG. 6 shows a tethering system that combines a two conductor electrical transmission line with the load-bearing tether. The mechanical strength is provided by the load bearing line 21, and rearwards on either side, two electrical conductors 22 are held in place by a series of triangular cable hangers 23, spaced at regular intervals. The resulting configuration is akin to the aerial spacer cable systems often deployed for terrestrial power distribution, with load-bearing line 21 doubling as the messenger cable. If electrically conductive and suitably grounded at the remote end, load-bearing tether line 21 may also serve as a shield wire for lightning protection.

Preferably, any form of tether should be of a length that is appropriate to ensure that airship 50 is able to be lofted at a height that strikes a balance between power generation capability and cost. A higher altitude requires a heavier, more expensive tether and therefore a more buoyant and more expensive airship. The cost of transmitting power in an efficient fashion also increases as the length of the tether increases. In practice therefore, the invention must strike a balance between altitude and device cost. For areas with low surface irregularities to interfere with the wind flow, an altitude range of anywhere between 100 and 500 meters, and typically 300 meters is suitable. In areas with substantial surface irregularities such as tall hills and mountains, a much higher altitude may be considered.

In an alternate embodiment of the current invention that may be suited to certain dedicated applications, an airborne power storage system such as one or more wing-mounted batteries may also be used in the place of a electrical transmission line to the surface.

As a protection against lightning strike when airship 50 is grounded, the craft may be equipped with a lightning arrestor. This may take the form of one or more upwardly projecting solid fineals, connected to one or a series of ground shunt cables. Provided they are positioned with sufficient clearance from the rotors, these shunt cables may hang free from the airship during flight, such that they can establish a connection to Earth during close ground approach.

As seen in FIG. 1, according to the preferred embodiment of the invention, there are mounted at each end of the main wing 6 a matched pair of wind generator systems. Each of these wind generators in turn comprise a nacelle 7 containing a rotary electrical generator and associated mechanical transmission, and turbine rotors 15 rotatably mounted to the rear of nacelle 7, preferably facing rearwards. In contrast to most terrestrially mounted wind turbines, where the rotor blades face into the wind, the preferable downwind orientation of the rotors 15 of the present invention serves to enhance the overall stability of the airborne system by placing the centre-of-drag to the rear of wing 6 and behind the load-bearing tether point 11. A second reason is to prevent the turbine rotors from tangling with the tether cable itself, and a third reason is to cause the rotors to provide lift rather than downward force when rotated upwards.

In an optional variant of the invention, the rotary electrical generators may drive onboard air compressors which capture ambient air from about airship 50 and compress it. According to this variant, the compressed air may be delivered to the surface via a pneumatic transmission line, such as a flexible high-pressure hose. In another variant the onboard air compressors may be mechanically coupled directly to output of rotors 15 by a suitable mechanical transmission. In the pneumatic variants, the pressurized air may be stored for later use in a pressure storage vessel, or may drive a ground-based pneumatically driven device directly.

As the power generated by a wind turbine is proportional to the swept area, the rotor diameter increases as the square root of the swept area. For typical design wind speeds, rotor blades of 2.5 meters length will give a turbine swept area on the order of 5 meters diameter for a turbine of less than 10 kilowatts output, and blades of 75 meters length would lead to a swept area of about 125 meters diameter, as for turbine rated in megawatts. The relationship between the size of the rotor and the capacity of the generator depends on the target range of operational wind speed. If the rotor is intended to operate in low wind conditions, then the rotor will be larger for a given generator capacity.

As is often seen in terrestrially mounted wind turbines, the turbine rotors 15 may be articulated on their mounting to allow for control of blade pitch. This allows the rate of rotation of the rotors to be adjusted, and will also vary the drag forces due to the turbine's interception of wind.

Each turbine rotor 15 is mechanically connected to the associated mechanical transmission by way of a coupling shaft, not shown in the Figures. Although the preferred embodiment depicted in the Figures is shown with one pair of turbine nacelles 7, multiple nacelles or nacelle sets may also be fitted. Preferably, the matched turbine rotors 15 on wing 6 are counter-rotating, as this feature allows each rotor 15 to counteract the angular momentum generated by the rotation of its opposite counterpart.

In most embodiments, wings 6 have active control surfaces 8 rotatably mounted to their trailing edge. These control surfaces may be in the form of flaps for the adjustment of the combined bilateral lift characteristics of wing 6, and as ailerons for the discrete variation of wing lift on one side or the other for the control of airship roll. Preferably, the twin functions of flaps and ailerons are combined into one single control surface per side, a configuration often described as a flaperon. In a flaperon design, the control surfaces on the left and right hand wing projection can be raised or lowered together to increase or decrease overall aerodynamic lift. The left and right hand flaperons may also be operated independently for control of roll. Given an adequate headwind, flaperon manipulation may be capable of allowing the airship to take off or land without additional intervention or other flight control manipulation. The flaperons may also serve as spoilers by purposefully compromising the aerodynamic lift characteristics of main wing 6. This is most useful when the airship is resting on the ground.

Attached to the rear of gas envelope 1, horizontal stabilizers comprising tailplanes 2 and vertical tailfins 3 provide stability with respect to pitch and yaw, and to enable the system to orient itself within a moving air mass such that the tail is downwind and to maintain that orientation in order to expose both the main wing 6 and the turbine rotors 15 to the wind flow. In another variant, not shown in the Figures, horizontal and/or vertical stabilizers may be mounted in canard fashion, located forward of the main wings 6 to stabilize and control the airship of the invention with respect to the wind.

The reader will note that, due to scaling requirements, the relative dimensional ratios between the aerostatic gas envelope 1, airfoils 2, 3 and 6, turbine rotors 15, and associated structure as depicted in the drawings will not necessarily work for all sizes of airship. In general, airship 50 should preferably be large enough to lift the entire combination of all components into the air, at least at lift-off from the ground under zero wind velocity conditions. Depending on the type of materials used and their weight, this consideration is likely to give rise to a minimum size for the overall combination to achieve commercial practicality.

In the preferred embodiment, articulated control surfaces are provided in the form of elevators 17 on the aft edge of tailplanes 2 and in the form of rudders 16 on vertical tailfin 3. Elevators 17 are rotatably attached at their forward edge to the tailplanes 2 such that they can be raised and lowered into or out of the horizontal plane of the tailplane to allow fine control of the attitude of airship 50 with respect to pitch. Rudders 17 are rotatably attached at their forward edge to the tailfins 3 such that they can be angled to the left and right into or out of the vertical plane of the tailfin to allow fine control of the attitude of airship 50 with respect to yaw.

Main wing 6, tailplanes 2, and tailfins 3, along with their associated control surfaces may also be provided with an electrical, mechanical, or chemical de-icing system to protect against lift or control impairment due to the accumulation of frozen contaminants during flight.

Also shown in FIG. 1, attached to bottom surface of main wing 6 is an undercarriage comprising left and right hand side landing gear, in order to prevent the turbine rotors 15 contacting the ground during approach or when airship 50 is parked. Each side's landing gear consists of a fore and aft fixed post 9. For stability reasons during high ground winds, it is preferable to have a landing gear posts 9 not much taller than that required to deal with the radius of the 7.5 kW turbine, or 2.5 meters.

Not shown in the Figures, but also contemplated as possible according to the invention, posts 9 may have shock absorbing devices fitted to absorb and dissipate forces associated with close ground approach under turbulent weather conditions. Posts 9 may also be provided horizontal elements 10 at their downward end to serve as landing skids. In some embodiments, the wings 6, the landing gear 9, and the downward projecting vertical tailfin 3 may have loops through which mooring lines can be placed to secure the system to the ground (not shown in Figures). Support struts may be fitted between the fixed posts and the wing, in order to secure the posts against movement in both axes, front to back and side to side. Alternatively, the landing gear may be provided in the form of keels rather than posts.

Also not shown in the Figures, but contemplated as possible according to the invention, is a “ripcord” venting system that, in the event of an emergency opens the main gas envelope, venting the gas in a controlled manner allowing a controlled decent. Operation of the ripcord may be effected wirelessly, so that the ripcord may be operable even if the airship breaks free of its tether.

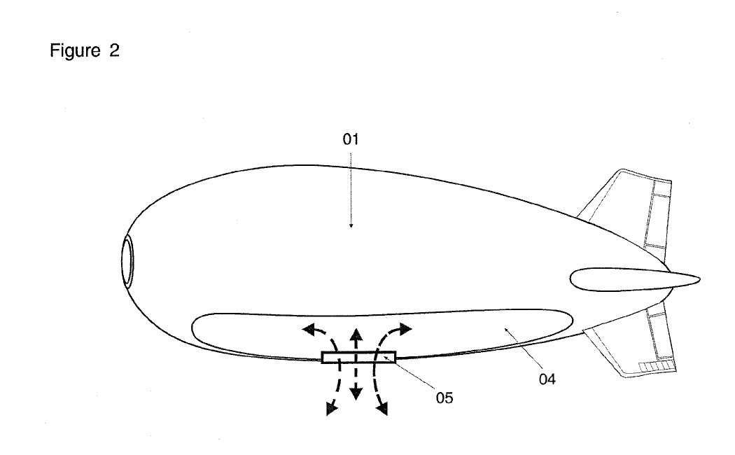

Turning to FIG. 2, there is shown an embodiment of the invention wherein the airship aerostatic gas envelope 1 also contains a ballast gas envelope or ballonet 4. Ballonet 4 is an expandable chamber located ventrally, inside the bottom of the nonrigid fuselage 20, that can be inflated or deflated as required with outside air. Turning on the ballonet inflator 5 inflates the ballonet 4 by pressurizing external ambient air into the ballonet envelope. This inflation increases the air pressure in the ballonet 4, thus displacing some of the volume previously occupied by the aerostatic gas envelope 1 and compressing the lifting gas. The resulting increased density of the lifting gas, coupled with the added weight of the air within the ballonet 4 leads to a decrease in the overall buoyancy of the airship 50. In this way, the ballasting system allows for the controlled modulation of the aerostatic lifting force acting upon the airship, a feature that can be used to raise of lower the airship in takeoff or landing, or for station-keeping purposes in actively maintaining or seeking a given operational altitude under changing wind or weather conditions.

According to the preferred embodiment of the current invention, the ballasting system serves two main functions. The first is to compensate for changes in the temperature of the lifting gas. As the lifting gas is heated or cooled, for example as a result of changes in the amount of solar radiation incident upon fuselage 20, the density of the lifting gas and hence its buoyancy relative to air will vary. Ballonet 4 may be inflated or deflated as required to compensate for this lift variation and maintain overall system buoyancy within a target range. Another function of the ballasting system is to allow for the deliberate modification of the overall buoyancy of the airship 50 in order to effect either a takeoff or landing of the airship 50. Preferably, ballonet 4 is designed with a volume capacity such that with the ballonet 4 maximally inflated, airship 50 will overall exhibit a slightly negative buoyancy, and will land gently with or without wind. Conversely, it is preferable that with the ballonet 4 deflated to or beyond a critical volume, airship 50 has enough positive buoyancy to lift off by itself and drag the tether aloft.

In another embodiment of the invention, the ballasting system may be implemented using a series of discrete ballonets located at different locations inside the airship envelope 1. If multiple ballonets are used, they may be operated independently to provide a degree of control over airship flight attitude via weight-shifting. Multiple ballonets may be regulated by a series of dedicated blowers, or through a vent and valve system from a single blower's output airstream.

Also depicted in FIG. 1 is an instrumentation and avionics package 27, rigidly attached within a cavity of the main wing 6 and accessible via a hatch from below. This pod serves to provide a weatherproof enclosure for any on-board equipment that may be fitted to airship 50, for example an automated flight control computer and some of the associated sensors. Although mounting the instrumentation and avionics package in an external streamlined pod may provide certain advantages with respect to maintenance access, mounting within a cavity of the main wing 6 is preferred.

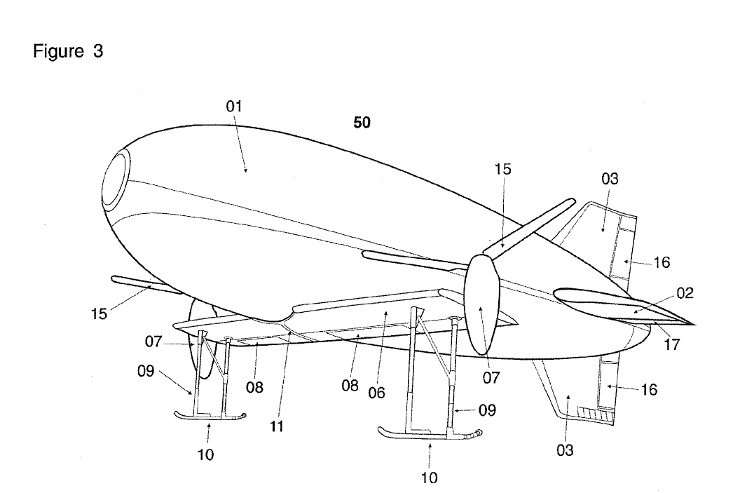

As shown in FIG. 3, turbine nacelles 7 may be rotatably mounted to the main wing 6, for instance at each wing end. This rotatable mounting allows the turbines to be turned upwards when landing, placing turbine rotors 15 horizontally above the wing 6 to avoid the need for tall landing gear. As there is a practical limit to the rotor to ground clearance that can be achieved by undercarriage posts 9 alone, rotating the turbines to the horizontal plane above the wing for close ground approach allows the system to be fitted with larger turbine rotor blades 15 than may be otherwise possible. Turbine attitudes lying between the horizontal and vertical rotor positions may also be assumed, in order to regulate turbine-related drag forces, vary the output of power generation, or to obtain an aerodynamic lift force from the rotors. The nacelle may also be tilted to allow rotor blades 15 to face the oncoming wind with a perpendicular plane of rotation when airship 50 is flying in a nose-up attitude.

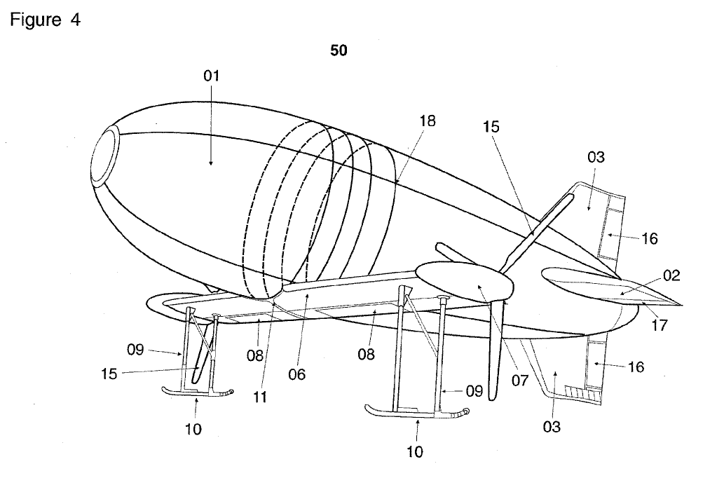

In FIG. 4 is depicted a main wing mounting system for affixing the wing 6 beneath the nonrigid fuselage 20. In this case a series of wing suspension cables 18 are looped over fuselage 20 in order to solidly hold wing 6 in a fixed orientation with the center of mass of the wing/turbine assembly depending directly beneath the airship's centre of aerostatic lift, and with the front edge of wing 6 perpendicular to the nose to tail centreline of fuselage 20. Individual wing suspension cables 18 are separated as the circle fuselage 20, in order to spread the wing assembly's weight over a greater surface area of fuselage 20. Cables 18 may be routed through guide loops attached to the surface of fuselage 20. To avoid abrasion and erosion of the skin of the airship, reinforcing fabric may be applied to the surfaces which contact cables 18.

Preferably, the remote anchoring end of the tether is fixed to the ground with sufficient strength to hold the airship in the desired location. The anchoring end should include a tether point, ideally comprising a rotatable joint to prevent tether fouling due to changes in prevailing wind direction. Also preferably included in or near the tether point may be a power storage facility such as a battery bank, or a power conditioning and metering system for relaying the generated electrical energy to a load or the distribution grid.

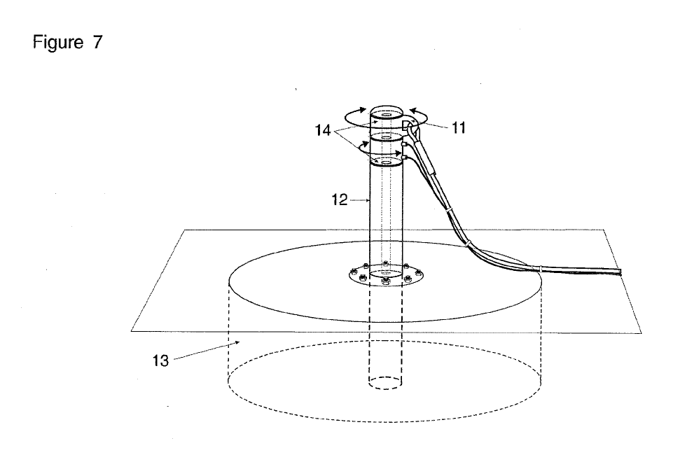

Shown in FIG. 7, a tether point is used that is fixed to the ground, in this case comprising a vertical tether post 12, which is embedded in concrete footing 13. Concrete footing 13 should be of sufficient mass to resist any tether tension arising from airship operation. The stability of concrete footing 13 to horizontal forces may be greatly enhanced by establishing it below grade, as in this case the surrounding earth will support the footing laterally. At the top of tether post 12 is a rotatable joint 14 with a cable attachment eye for the attachment of load-bearing line 21. In the preferred embodiment, provision is also made for the connection of the electrical transmission cables to cable receivers below the rotating joint 14. In order to avoid fouling of the transmission line cables around tether post 12, cable receivers may be electrically connected to the load feed by way of a pair of slip ring conductor assemblies.

Alternative methods of anchoring the system to the ground include fixing the tether post 12 to a plate or frame, and using ground screws or ground anchors to fix the plate to the ground.

As an alternative to fixed ground anchoring, a vehicle such as a truck, boat, or ship may be used as the tether point to which the airship is fixed. Also, in some cases it may be advantageous to anchor tether line 21 by way of a winch or spool, in order to reduce the size of the airship flight exclusion area surrounding the tether point.

Embodiments of the airborne wind powered generator may include automatic or manual controls, or both. An Automatic Flight Control System may receive inputs from sensors such as anemometers or other wind speed instrumentation, gas pressure sensors, lightning detectors, gyroscopes or gravitationally-based attitude detectors, and so forth, in order to compute instructions or instruction sequences for the various flight control systems, for purposes of dynamically maintaining a given airship position and attitude, or to effect unattended operational maneuvers such as takeoff or landing.

An automated control system may for example be used to autonomously land the craft during potentially damaging or dangerous weather conditions, based on criteria of wind speed, lightning discharge density and location, or changes in barometric pressure. Similarly, when environmental conditions according to those same metrics have subsequently improved, the control system may be used to initiate the control sequence suitable for restoration of the airship's power generating station aloft. Identification of the aforementioned damaging or dangerous weather conditions may be made locally, or this information may be made available from a remote source.

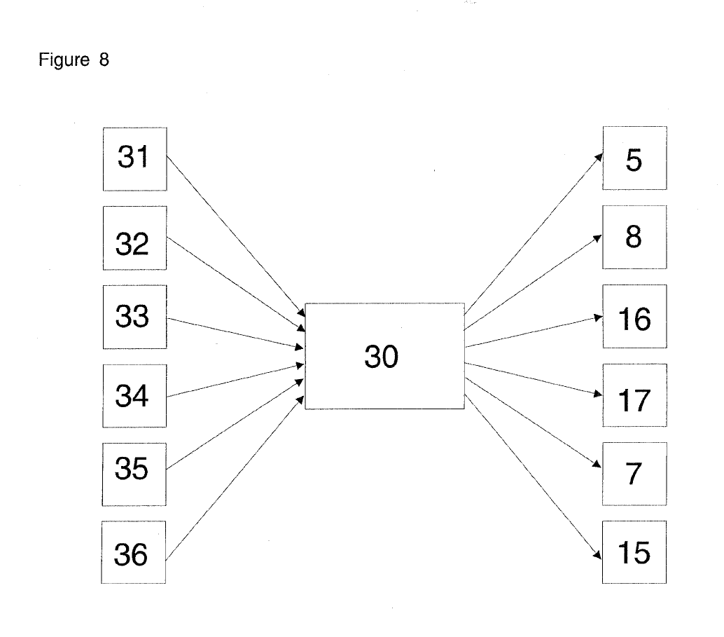

FIG. 8 depicts in block diagram one variant of an automated flight control system which may be mounted aboard airship 50. A flight control computer 30 is provided, which may read airship attitude information from roll sensor 31, pitch sensor 32, and yaw sensor 33. In addition, one or more wind speed sensors 34, a barometric pressure sensor 35, sensor for altitude above terrain 36, or other sensors may be provided. The attitude detection instruments may be discrete devices, for example gravity operated sensors, or may be combined into a single instrument such as an integrated gyroscope package. The control computer 30 is equipped with actuator control outputs to allow it to operate the ballonet inflator 5, flaperons 8, rudder 16 and elevator 17 by signaling the relevant actuators for station-keeping or maneuvering. In systems so equipped, the flight control computer may also operate actuators in order to change the tilt angle of wind turbine nacelles 7, and vary the pitch of rotor blades 15, in order to adjust the turbine's lift-to-drag ratio or to govern electrical power generation in changing wind speed.

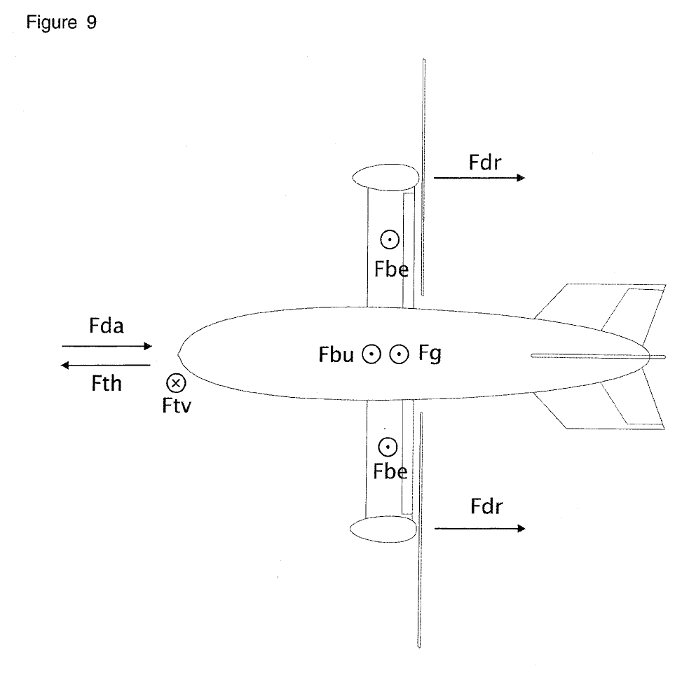

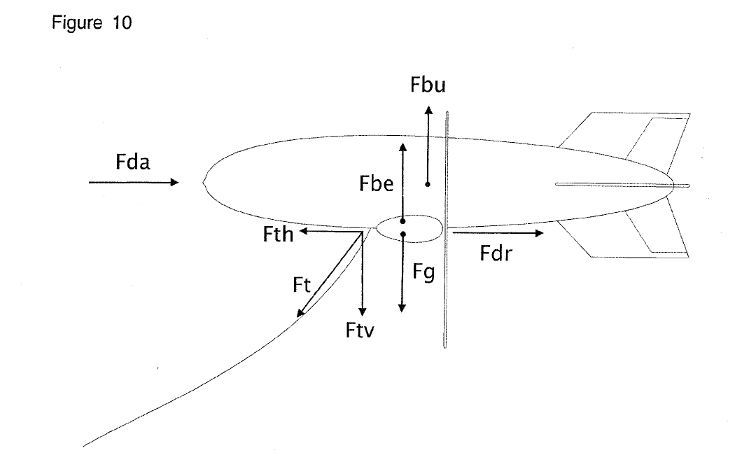

In FIGS. 9 and 10 are shown, in top and side view respectively, the forces acting on the airship during level flight. In this attitude, the maintenance of a given altitude requires that the combined magnitude of the aerostatic lifting force due to buoyancy of the lighter than air gas Fbu and aerodynamic lifting forces from the main wing Fbe, must equal that of the force of gravity Fg, acting on the airship and the vertical component of the force imparted from the tethering system Ftv. When the combination of Fbu and Fbe exceeds Fg and Ftv, the airship will rise, and when the opposite occurs it will descend. As discussed earlier, the aerostatic lifting force Fbu may be modified by the operation of the ballonet system, and the aerodynamic lifting force Fbe may be adjusted by trimming the flaps or flaperons. While the aerostatic lifting force Fbu is independent of wind speed, the lifting force Fbe from the wing will increase as wind speed goes up.

In order to maintain station horizontally, the combined magnitude of the horizontal drag forces on the airship Fda and on the turbine rotors Fdr must equal the horizontal component of the force imparted from the tethering system Fth. If the wind speed increases, then the airship, constrained by the tether, will begin to trace an arc about the tether's remote attachment point that will cause it to move downwind and downward allowing drag forces Fda and Fdr to reach a new equilibrium with horizontal tether force Fth. In this case however, the increased wind speed leads to a corresponding increase in aerodynamic lift from the main wings Fbe, allowing the airship to maintain a greater altitude than would be possible in the absence of the wings.

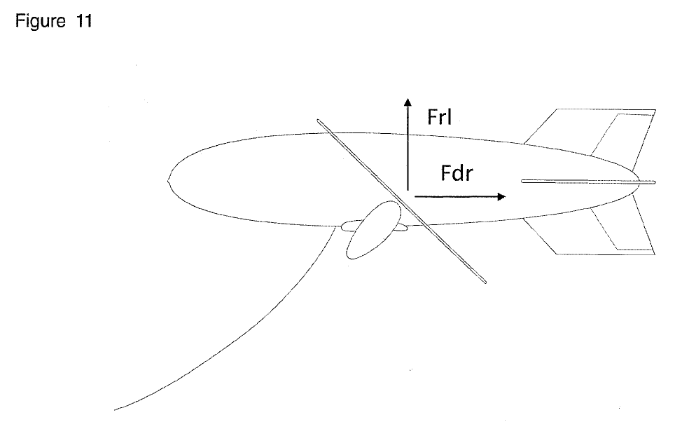

FIG. 11 shows the system with the generator nacelles tilted off horizontal, in a mode that allows the rotors to trade drag for lift. Rotor turbine attitudes lying between the horizontal and vertical rotor positions will lead to a diminished horizontal rotor drag Fdr, while introducing a new aerodynamic lifting force factor Frl. This adjustable lift-to-drag ratio may be used to modulate power output in high winds or as an additional option for altitude control.

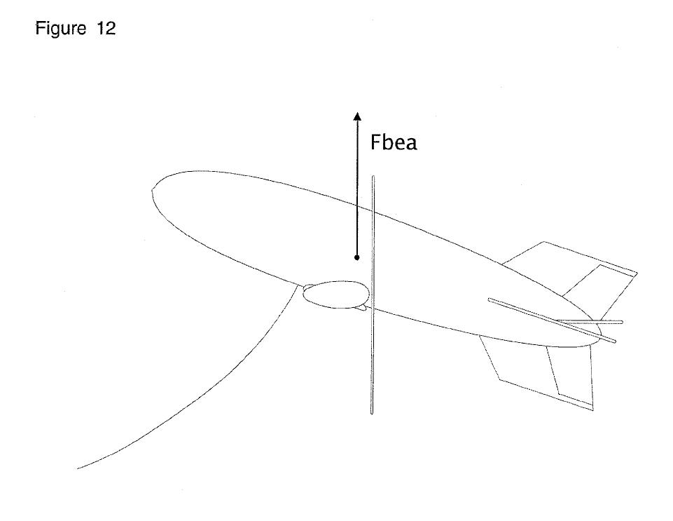

FIG. 12 shows another flight attitude for achieving additional lift from the airship fuselage itself. In this case, the craft has assumed a nose-up mode, either due to the operation of the tailplane elevators, or by differential inflation of front and rear ballonets to bias the tail heavier. As a result, the horizontal drag on the airship Fda will be reduced, and a new lift component Fbea will be generated. In order to maintain the turbine rotors' plane of rotation facing perpendicular to the oncoming wind, the nacelles are rotated upwards to correct for airship pitch.

Although the foregoing description relates to specific preferred embodiments of the present invention, it will be understood that various changes, modifications and adaptations, may be made without departing from the spirit of the invention.

### CONCLUSION

The foregoing has constituted a description of specific embodiments showing how the invention may be applied and put into use. These embodiments are only exemplary. The invention in its broadest, and the more specific aspects, is further described and defined in the claims which now follow.

These claims, and the language used therein, are to be understood in terms of the variants of the invention which have been described. They are not to be restricted to such variants, but are to be read as covering the full scope of the invention as is implicit within the invention and the disclosure that has been provided herein.

The embodiments of the invention in which an exclusive property or privilege is claimed are defined as follows:

1. A wind generator and airship combination for generating electrical power from wind energy, comprising:
a) an airship gas envelope fillable with a lighter-than-air lifting gas to provide the airship with a first upwardly directed lifting force component due to the relative buoyancy of the gas with respect to that of the ambient atmosphere;
b) at least one main fixed airfoil member to impart to the airship a second lifting force component due to aerodynamic effects in response to airflow about the airfoil member;
c) a tethering member for attaching the airship to a remote tether point on the earth's surface;
d) a wind generator system comprising at least one wind turbine for capturing kinetic energy from the relative motion of winds about the airship and converting the captured kinetic energy to mechanical energy, and a rotary electrical generator for converting the wind-derived mechanical energy to generated electrical power; and
e) an electrical power transmission system for transfer of the generated electrical power from the airship to an electrical load connection;
whereby, when exposed to the wind, the main fixed airfoil can impart to the airship an upwardly directed positive airfoil lifting force component responsive to wind speed about the airship to supplement the buoyancy of the lifting gas.

2. The airship of claim 1, wherein the main airfoil is dimensioned and shaped to provide a lifting force component that is of sufficient magnitude to limit the descent of the airship under increased windspeeds and maintain a greater airship altitude than would occur in the absence of the airfoil.

3. The airship of claim 2, further comprising at least one trailing airfoil located aft of the main airfoil for stabilizing airship attitude with respect to yaw.

4. The airship of claim 3, where at least one trailing airfoil is in the form of a vertically oriented tailfin.

5. The airship of claim 4, where the at least one vertically oriented tailfin is provided with at least one active control surface for adjusting airship attitude with respect to yaw.

6. The airship of claim 5, where at least one trailing airfoil is in the form of a horizontally oriented tailplane for stabilizing airship attitude with respect to pitch.

7. The airship of claim 6, where at least one horizontally oriented tailplane is provided with at least one active control surface for adjusting airship attitude with respect to pitch.

8. The airship of claim 7, where at least one main airfoil member is provided with at least one active control surface for adjusting the aerodynamic lift forces arising from the airfoil and to adjust airship attitude with respect to roll.

9. The airship of claim 8, further comprising at least one ballast ballonet located within the airship envelope, and a ballonet control pump for inflating and deflating the at least one ballonet, wherein the upwardly directed lifting force component due to the relative buoyancy of the lifting gas may be adjusted by inflating and deflating the ballonet to thereby vary the overall buoyancy of the airship.

10. The airship of claim 8, further comprising a dynamic attitude control system, comprising at least one sensor for the determination of the airship's attitude in space, and an automatic flight control computer to read the sensor's output and compute and output instructions or instruction sequences to the active control systems, whereby the active control surfaces are adjusted to compensate for changes in airship attitude and maintain a given attitude in flight.

11. The airship of claim 2, whereby the remote electrical load connection is located proximally to the remote tether point, and the electrical power transmission medium comprises at least one electrically conductive cable extending from the airship to the tether point.

12. The airship of claim 11, whereby at least one electrically conductive cable is integrated and co-extensive with the airship tethering member.

13. The airship of claim 2, further comprising a set of landing gear wherein the landing gear are of a sufficient height to prevent the rotor blades from contacting the ground when the airship is grounded.

14. The airship of claim 13, wherein the rotors are rotatably mounted to allow their axis of rotation to be tilted, in order to increase the clearance between the rotor blades and ground when the airship is not airborne.
